(19) United States
(12) Patent Application Publication
(10) Pub. No.: US 2012/0205345 A1
(43) Pub. Date: Aug. 16, 2012

(54) TREATMENT SOLUTION FOR PREVENTING PATTERN COLLAPSE IN METAL FINE STRUCTURE BODY, AND PROCESS FOR PRODUCTION OF METAL FINE STRUCTURE BODY USING SAME

(75) Inventors: Masaru Ohto, Chiba (JP); Hiroshi Matsunaga, Tokyo (JP); Kenji Yamada, Tokyo (JP)

(73) Assignee: MITSUBISHI GAS CHEMICAL COMPANY, INC., Chiyoda-ku, Tokyo (JP)

(21) Appl. No.: 13/503,055

(22) PCT Filed: Oct. 19, 2010
(86) PCT No.: PCT/JP2010/068397

§ 371 Date: Apr. 20, 2012

(30) Foreign Application Priority Data
Oct. 23, 2009 (JP) 2009-244542

(51) Int. Cl. C23F 1/00; C11D 3/20

(52) U.S. Cl. 216/101; 510/175; 216/102

(57) ABSTRACT

There are provided a processing liquid for suppressing pattern collapse of a fine metal structure, containing a pattern collapse suppressing agent that has a hydrocarbyl group containing any one of an alkyl group and an alkenyl group, both of which may be substituted partly or entirely by a fluorine atom, and contains an oxyethylene structure, and a method for producing a fine metal structure using the same.

### TECHNICAL FIELD

The present invention relates to a processing liquid for suppressing pattern collapse of a fine metal structure, and a method for producing a fine metal structure using the same.

### BACKGROUND ART

The photolithography technique has been employed as a formation and processing method of a device having a fine structure used in a wide range of fields of art including a semiconductor device, a circuit board and the like. In these fields of art, reduction of size, increase of integration degree and increase of speed of a semiconductor device considerably proceed associated with the highly sophisticated demands on capabilities, which bring about continuous miniaturization and increase of aspect ratio of the resist pattern used for photolithography. However, the progress of miniaturization of the resist pattern causes pattern collapse as a major problem.

It has been known that upon drying a resist pattern from a processing liquid used in wet processing (which is mainly a rinsing treatment for washing away the developer solution) after developing the resist pattern, the collapse of the resist pattern is caused by the stress derived by the surface tension of the processing liquid. For preventing the collapse of the resist pattern, such methods have been proposed as a method of replacing the rinsing liquid by a liquid having a low surface tension using a nonionic surfactant, a compound soluble in an alcohol solvent, or the like (see, for example, Patent Documents 1 and 2), and a method of hydrophobizing the surface of the resist pattern (see, for example, Patent Document 3).

In a fine structure formed of a metal, a metal nitride, a metal oxide or the like (which may be hereinafter referred to as a fine metal structure, and a metal, a silicon-containing metal, a metal nitride, a metal oxide or the like may be hereinafter referred totally as a metal) by the photolithography technique, the strength of the metal itself constituting the structure is larger than the strength of the resist pattern itself or the bonding strength between the resist pattern and the substrate, and therefore, the collapse of the structure pattern is hard to occur as compared to the resist pattern. However, associated with the progress of reduction of size, increase of integration degree and increase of speed of a semiconductor device and a micromachine, the pattern collapse of the structure is becoming a major problem due to miniaturization and increase of aspect ratio of the resist pattern. The fine metal structure has a surface state that is totally different from that of the resist pattern, which is an organic material, and therefore, there is no effective measure for preventing the pattern collapse of the structure. Accordingly, the current situation is that the degree of freedom on designing the pattern for producing a semiconductor device or a micromachine with reduced size, increased integration degree and increased speed is considerably impaired since the pattern is necessarily designed for preventing the pattern collapse.

### PRIOR ART DOCUMENTS

### Patent Documents

Patent Document 1: JP-A-2004-184648
Patent Document 2: JP-A-2005-309260
Patent Document 3: JP-A-2006-163314

### SUMMARY OF THE INVENTION

### Problems to be Solved by the Invention

As described above, the current situation is that no effective technique for suppressing pattern collapse has been known in the field of a fine metal structure, such as a semiconductor device and a micromachine.

The present invention has been developed under the circumstances, and an object thereof is to provide a processing liquid that is capable of suppressing pattern collapse of a fine metal structure, such as a semiconductor device and a micromachine, and a method for producing a fine metal structure using the same.

### Means for Solving the Problems

As a result of earnest investigations made by the inventors for achieving the object, it has been found that the object can be achieved with a processing liquid containing a pattern collapse suppressing agent that has a hydrocarbyl group containing any one of an alkyl group and an alkenyl group, both of which may be substituted partly or entirely by a fluorine atom, and contains an oxyethylene structure.

The present invention has been completed based on the finding. Accordingly, the gist of the present invention is as follows.

(1) A processing liquid for suppressing pattern collapse of a fine metal structure, containing a pattern collapse suppressing agent that has a hydrocarbyl group containing any one of an alkyl group and an alkenyl group, both of which may be substituted partly or entirely by a fluorine atom, and contains an oxyethylene structure.

(2) The processing liquid for suppressing pattern collapse of a fine metal structure according to the item (1), wherein the pattern collapse suppressing agent is at least one selected from the group consisting of a hydrocarbyl alkanolamide, a polyoxyethylene hydrocarbylamine and a perfluoroalkyl polyoxyethylene ethanol.

(3) The processing liquid according to the item (2), wherein the hydrocarbyl alkanolamide is represented by the following general formula (1):

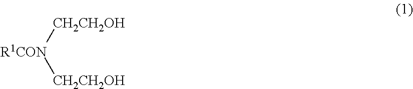

wherein R¹ represents an alkyl group having from 2 to 24 carbon atoms or an alkenyl group.

(4) The processing liquid according to the item (2), wherein the polyoxyethylene hydrocarbylamine is represented by the following general formula (2):

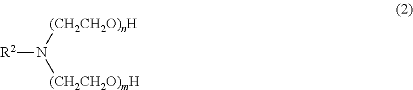

wherein R² represents an alkyl group having from 2 to 24 carbon atoms or an alkenyl group; and n and m each represent an integer of from 0 to 20, provided that n and m may be the same as or different from each other, and m+n is 1 or more.

(5) The processing liquid according to the item (2), wherein the perfluoroalkyl polyoxyethylene ethanol is represented by the following general formula (3):

CF₃(CF₂)ₙ(CH₂CH₂O)ₘCH₂CH₂OH (3)

wherein n and m each represent an integer of from 1 to 20, provided that n and m may be the same as or different from each other.

(6) The processing liquid according to any of the items (1) to (5), which further contains water.

(7) The processing liquid according to any of the items (2) to (6), wherein a content of the at least one selected from the group consisting of a hydrocarbyl alkanolamide, a polyoxyethylene hydrocarbylamine and a perfluoroalkyl polyoxyethylene ethanol is from 10 ppm to 10%.

(8) The processing liquid according to any of the items (1) to (7), wherein the fine metal structure contains partly or entirely at least one material selected from titanium nitride, titanium, ruthenium, ruthenium oxide, aluminum oxide, hafnium oxide, hafnium silicate, hafnium nitride silicate, platinum, tantalum, tantalum oxide, tantalum nitride, nickel silicide, nickel silicon germanium and nickel germanium.

(9) A method for producing a fine metal structure, containing after wet etching or dry etching, a rinsing step using the processing liquid according to any of the items (1) to (8).

(10) The method for producing a fine metal structure according to the item (9), wherein the fine metal structure contains partly or entirely at least one material selected from titanium nitride, titanium, ruthenium, ruthenium oxide, aluminum oxide, hafnium oxide, hafnium silicate, hafnium nitride silicate, platinum, tantalum, tantalum oxide, tantalum nitride, nickel silicide, nickel silicon germanium and nickel germanium.

(11) The method for producing a fine metal structure according to the item (9) or (10), wherein the fine metal structure is a semiconductor device or a micromachine.

### Advantages of the Invention

According to the present invention, there are provided a processing liquid that is capable of suppressing pattern collapse of a fine metal structure, such as a semiconductor device and a micromachine, and a method for producing a fine metal structure using the same.

### BRIEF DESCRIPTION OF THE DRAWINGS

FIG. 1

The figure includes schematic cross sectional views of each production steps of fine metal structures produced in Examples 1 to 8 and Comparative Examples 1 to 20.

FIG. 2

The figure includes schematic cross sectional views of each production steps of fine metal structures produced in Examples 9 to 24 and Comparative Examples 21 to 60.

### MODE FOR CARRYING OUT THE INVENTION

The processing liquid for suppressing pattern collapse of a fine metal structure contains a pattern collapse suppressing agent that has a hydrocarbyl group containing any one of an alkyl group and an alkenyl group, both of which may be substituted partly or entirely by a fluorine atom, and contains an oxyethylene structure. It is considered that the oxyethylene structure moiety of the pattern collapse suppressing agent is adsorbed to the metal material used in the pattern of the fine metal structure, and the hydrocarbyl group extending therefrom exhibits hydrophobicity, thereby hydrophobizing the surface of the pattern. It is considered as a result that generation of stress caused by the surface tension of the processing liquid is suppressed, and pattern collapse of a fine metal structure, such as a semiconductor device and a micromachine, is suppressed.

The hydrophobization in the present invention means that the contact angle of the metal surface having been processed with the processing liquid of the present invention with respect to water is 70° or more. The “oxyethylene structure” in the present invention means a structure “—CH₂CH₂O—”.

The pattern collapse suppressing agent used in the processing liquid of the present invention is preferably at least one selected from the group consisting of a hydrocarbyl alkanolamide, a polyoxyethylene hydrocarbylamine and a perfluoroalkyl polyoxyethylene ethanol.

Preferred examples of the hydrocarbyl alkanolamide include a compound represented by the following general formula (1):

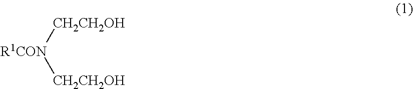

In the formula, R¹ represents an alkyl group having from 2 to 24 carbon atoms or an alkenyl group. The alkyl group is preferably an alkyl group having from 6 to 18 carbon atoms, more preferably an alkyl group having from 8 to 18 carbon atoms, and further preferably an alkyl group having 8, 10, 12, 14, 16 or 18 carbon atoms. The alkyl group may be either linear, branched or cyclic, and may have a halogen atom and a substituent.

Examples thereof include various kinds of hexyl groups, such as a n-hexyl group, a 1-methylhexyl group, a 2-methylhexyl group, a 1-pentylhexyl group, a cyclohexyl group, a 1-hydroxyhexyl group, a 1-chlorohexyl group, a 1,3-dichlorohexyl group, a 1-aminohexyl group, a 1-cyanohexyl group and a 1-nitrohexyl group, and also various kinds of heptyl groups, various kinds of octyl groups, various kinds of nonyl groups, various kinds of decyl groups, various kinds of undecyl groups, various kinds of dodecyl groups, various kinds of tridecyl groups, various kinds of tetradecyl groups, various kinds of pentadecyl groups, various kinds of hexadecyl group, various kinds of heptadecyl groups, various kinds of octadecyl groups, various kinds of nonadecyl groups and various kinds of eicosyl groups, more preferably various kinds of hexyl groups, various kinds of heptyl groups, various kinds of octyl groups, various kinds of nonyl groups, various kinds of decyl groups, various kinds of undecyl groups, various kinds of dodecyl groups, various kinds of tridecyl groups, various kinds of tetradecyl groups, and various kinds of octadecyl groups, and further preferably various kinds of octyl groups, various kinds of decyl groups, various kinds of dodecyl groups, various kinds of tetradecyl groups, various kinds of cetyl groups and various kinds of octadecyl groups.

The alkenyl group is preferably an alkenyl group having from 2 to 24 carbon atoms, more preferably an alkenyl group having from 4 to 18 carbon atoms, and further preferably an alkenyl group having from 6 to 18 carbon atoms.

Preferred examples of the polyoxyethylene hydrocarbylamine include a compound represented by the following general formula (2):

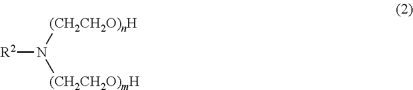

In the formula (2), R² represents an alkyl group having from 2 to 24 carbon atoms or an alkenyl group having from 2 to 24 carbon atoms. The alkyl group is preferably an alkyl group having from 6 to 18 carbon atoms, more preferably an alkyl group having from 8 to 18 carbon atoms, further preferably an alkyl group having 8, 10, 12, 14, 16 or 18 carbon atoms, and particularly preferably one having 18 carbon atoms. The alkyl group may be either linear, branched or cyclic, and may have a halogen atom and a substituent. Examples thereof include various kinds of hexyl groups, such as a n-hexyl group, a 1-methylhexyl group, a 2-methylhexyl group, a 1-pentylhexyl group, a cyclohexyl group, a 1-hydroxyhexyl group, a 1-chlorohexyl group, a 1,3-dichlorohexyl group, a 1-aminohexyl group, a 1-cyanohexyl group and a 1-nitrohexyl group, and also various kinds of heptyl groups, various kinds of octyl groups, various kinds of nonyl groups, various kinds of decyl groups, various kinds of undecyl groups, various kinds of dodecyl groups, various kinds of tridecyl groups, various kinds of tetradecyl groups, various kinds of pentadecyl groups, various kinds of hexadecyl group, various kinds of heptadecyl groups, various kinds of octadecyl groups, various kinds of nonadecyl groups and various kinds of eicosyl groups, more preferably various kinds of hexyl groups, various kinds of heptyl groups, various kinds of octyl groups, various kinds of nonyl groups, various kinds of decyl groups, various kinds of undecyl groups, various kinds of dodecyl groups, various kinds of tridecyl groups, various kinds of tetradecyl groups, and various kinds of octadecyl groups, further preferably various kinds of octyl groups, various kinds of decyl groups, various kinds of dodecyl groups, various kinds of tetradecyl groups, various kinds of cetyl groups and various kinds of octadecyl groups, and particularly preferably various kinds of octadecyl groups.

The alkenyl group is preferably an alkenyl group having from 2 to 24 carbon atoms, more preferably an alkenyl group having from 4 to 18 carbon atoms, and further preferably an alkenyl group having from 6 to 18 carbon atoms.

In the formula, n and m each represent an integer of from 0 to 20, preferably from 0 to 14, and more preferably from 1 to 5 (provided that m+n is 1 or more). When m and n are in the range, the polyoxyethylene hydrocarbylamine used in the present invention is easily soluble in a solvent such as water and an organic solvent, and may be favorably used as the processing liquid though it is depended on influence of a hydrophilic-hydrophobic balance against a functional group represented by R² in the formula.

Particularly preferred examples of the compound represented by the general formula (1) include a coconut oil fatty acid diethanolamide, and examples thereof include one having R¹ that is a mixture of a number of carbon atoms of from 8 to 18, and a number of carbon atoms of 8, 10, 12, 14, 16 or 18. Specific examples thereof include Dianol 300, a product name (produced by Dai-ichi Kogyo Seiyaku Co., Ltd.), Dianol CDE, a product name (produced by Dai-ichi Kogyo Seiyaku Co., Ltd.), Amisol CDE, a product name (produced by Kawaken Fine Chemicals Co., Ltd.), and Amisol FDE, a product name (produced by Kawaken Fine Chemicals Co., Ltd.).

Preferred examples of the compound represented by the general formula (2) include Amiet 102, a product name, Amiet 105, a product name, Amiet 105A, a product name, Amiet 302, a product name, and Amiet 320, a product name, (all produced by Kao Corporation), and particularly preferred examples thereof include polyoxyethylene stearylamine, specific examples of which include Amiradine D, a product name (produced by Dai-ichi Kogyo Seiyaku Co., Ltd.), and Amiradine C-1802, a product name (produced by Dai-ichi Kogyo Seiyaku Co., Ltd.).

The perfluoroalkyl polyoxyethylene ethanol may be a compound represented by the general formula (3), specific examples of which include Fluorad FC-170C (produced by Sumitomo 3M, Ltd.)

CF₃(CF₂)ₙ(CH₂CH₂O)ₘCH₂CH₂OH (3)

wherein n and m each represent an integer of from 1 to 20, provided that n and m may be the same as or different from each other.

The processing liquid of the present invention preferably further contains water and is preferably an aqueous solution. Preferred examples of the water include water, from which metallic ions, organic impurities, particles and the like are removed by distillation, ion exchange, filtering, adsorption treatment or the like, and particularly preferred examples thereof include pure water and ultrapure water.

The processing liquid of the present invention contains the at least one member selected from the group consisting of a hydrocarbyl alkanolamide, a polyoxyethylene hydrocarbylamine and a perfluoroalkyl polyoxyethylene ethanol, preferably contains water, and may contain various kinds of additives that are ordinarily used in processing liquids in such a range that does not impair the advantages of the processing liquid.

The content of the at least one member selected from the group consisting of a hydrocarbyl alkanolamide, a polyoxyethylene hydrocarbylamine and a perfluoroalkyl polyoxyethylene ethanol in the processing liquid of the present invention is preferably from 10 ppm to 10%. When the content of the compounds is in the range, the advantages of the compounds may be sufficiently obtained, and in consideration of handleability, economy and foaming, the content is preferably 5% or less, more preferably from 10 ppm to 1%, further preferably from 10 to 2,000 ppm, and particularly preferably from 10 to 1,000 ppm. In the case where the compounds do not have sufficient solubility in water to cause phase separation, an organic solvent, such as an alcohol, may be added, and an acid or an alkali may be added to enhance the solubility.

Even in the case where the processing liquid is simply turbid white without phase separation, the processing liquid may be used in such a range that does not impair the advantages of the processing liquid, and may be used while stirring to make the processing liquid homogeneous. Furthermore, for avoiding the white turbidity of the processing liquid, the processing liquid may be used after adding an organic solvent, such as an alcohol, an acid or an alkali thereto as similar to the above case.

The processing liquid of the present invention may be used favorably for suppressing pattern collapse of a fine metal structure, such as a semiconductor device and a micromachine. Preferred examples of the pattern of the fine metal structure include ones containing at least one member selected from TiN (titanium nitride), Ti (titanium), Ru (ruthenium), RuO (ruthenium oxide), SrRuO₃ (strontium ruthenium oxide), Al₂O₃ (aluminum oxide), HfO₂ (hafnium oxide), HfSiOₓ (hafnium silicate), HfSiON (hafnium nitride silicate), Pt (platinum), Ta (tantalum), Ta₂O₅ (tantalum oxide), TaN (tantalum nitride), NiSi (nickel silicide), NiSiGe (nickel silicon germanium), NiGe (nickel germanium) and the like, more preferably TiN (titanium nitride), Ti (titanium), Ru (ruthenium), RuO (ruthenium oxide), SrRuO₃ (strontium ruthenium oxide), Al₂O₃ (aluminum oxide), HfO₂ (hafnium oxide), Pt (platinum), Ta (tantalum), Ta₂O₅ (tantalum oxide) and TaN (tantalum nitride), and further preferably TiN (titanium nitride), Ta (tantalum), Ti (titanium), Al₂O₃ (aluminum oxide), HfO₂ (hafnium oxide) and Ru (ruthenium). The fine metal structure may be patterned on an insulating film species, such as SiO₂ (a silicon oxide film) and TEOS (a tetraethoxy ortho silane oxide film), in some cases, or the insulating film species is contained as a part of the fine metal structure in some cases.

The processing liquid of the present invention can exhibit excellent pattern collapse suppressing effect to not only an ordinary fine metal structure, but also a fine metal structure with further miniaturization and higher aspect ratio. The aspect ratio referred herein is a value calculated from (height of pattern/width of pattern), and the processing liquid of the present invention may exhibit excellent pattern collapse suppressing effect to a pattern that has a high aspect ratio of 3 or more, and further 7 or more. The processing liquid of the present invention has excellent pattern collapse suppressing effect to a finer pattern with a pattern size (pattern width) of 300 nm or less, further 150 nm or less, and still further 100 nm or less, and with a pattern size of 50 nm or less and a line/space ratio of 1/1, and similarly to a finer pattern with a pattern distance of 300 nm or less, further 150 nm or less, still further 100 nm or less, and still further 50 nm or less and a cylindrical hollow or cylindrical solid structure.

### Method for Producing Fine Metal Structure

The method for producing a fine metal structure of the present invention contains, after wet etching or dry etching, a rinsing step using the processing liquid of the present invention. More specifically, in the rinsing step, it is preferred that the pattern of the fine metal structure is made in contact with the processing liquid of the present invention by dipping, spray ejecting, spraying or the like, then the processing liquid is replaced by water, and the fine metal structure is dried. In the case where the pattern of the fine metal structure and the processing liquid of the present invention are in contact with each other by dipping, the dipping time is preferably from 10 seconds to 30 minutes, more preferably from 15 seconds to 20 minutes, further preferably from 20 seconds to 15 minutes, and particularly preferably from 30 seconds to 10 minutes, and the temperature condition is preferably from 10 to 60° C., more preferably from 15 to 50° C., further preferably from 20 to 40° C., and particularly preferably from 25 to 40° C. The pattern of the fine metal structure may be rinsed with water before making in contact with the processing liquid of the present invention. The contact between the pattern of the fine metal structure and the processing liquid of the present invention enables suppression of collapse of the pattern, in which a pattern is in contact with the adjacent pattern, through hydrophobization of the surface of the pattern.

The processing liquid of the present invention may be applied widely to a production process of a fine metal structure irrespective of the kind of the fine metal structure, with the production process having a step of wet etching or dry etching, then a step of wet processing (such as etching, cleaning or rinsing for washing the cleaning liquid), and then a drying step. For example, the processing liquid of the present invention may be favorably used after the etching step in the production process of a semiconductor device or a micromachine, for example, (i) after wet etching of an insulating film around an electroconductive film in the production of a DRAM type semiconductor device (see, for example, JP-A-2000-196038 and JP-A-2004-288710), (ii) after a rinsing step for removing contamination formed after dry etching or wet etching upon processing a gate electrode in the production of a semiconductor device having a transistor with a fin in the form of strips (see, for example, JP-A-2007-335892), and (iii) after a rinsing step for removing contamination formed after etching for forming a cavity by removing sacrifice layer formed of an insulating film through a through hole in an electroconductive film upon forming a cavity of a micromachine (electrodynamic micromachine) (see, for example, JP-A-2009-122031).

### EXAMPLE

The present invention will be described in more detail with reference to examples and comparative examples below, but the present invention is not limited to the examples.

### Preparation of Processing Liquid

Processing liquids for suppressing pattern collapse of a fine metal structure 1 to 4 of the examples were prepared according the formulation compositions (% by mass) shown in Table 1. The balance is water.

TABLE 1

| | | Number of carbon | |
|---|---|---|---|
| | Kind | atoms of alkyl group *5 | Content |
| Processing liquid 1 | coconut oil fatty acid diethanolamide (1/2 type) *1 | mixture of C8 to C18 | 1% |
| Processing liquid 2 | coconut oil fatty acid diethanolamide (1/1 type) *2 | mixture of C8 to C18 | 5,000 ppm |
| Processing liquid 3 | polyoxyethylene stearylamine *3 | C18 | 1,000 ppm |
| Processing liquid 4 | perfluoroalkyl polyoxyethylene ethanol *4 | fluoroalkyl group | 100 ppm |

*1: “Dianol 300 (product name)”, produced by Dai-ichi Kogyo Seiyaku Co., Ltd., specific gravity: 1.01 (20° C.), viscosity: ca. 1,100 Pas (25° C.), nonionic, with the scope of the general formula (1)
*2: “Dianol CDE (product name)”, produced by Dai-ichi Kogyo Seiyaku Co., Ltd., specific gravity: 1.01 (20° C.), viscosity: ca. 220 Pas (50° C.), nonionic, with the scope of the general formula (1)
*3: “Amiradine C-1802 (product name)”, produced by Dai-ichi Kogyo Seiyaku Co., Ltd., specific gravity: 0.916 (20° C.), nonionic, with the scope of the general formula (2)
*4: “Fluorad FC-170C (product name)”, produced by Sumitomo 3M, Ltd., specific gravity: 1.32 (25° C.), nonionic, with the scope of the general formula (3)
*5: number of carbon atoms of alkyl group of compounds

### Examples 1 to 4

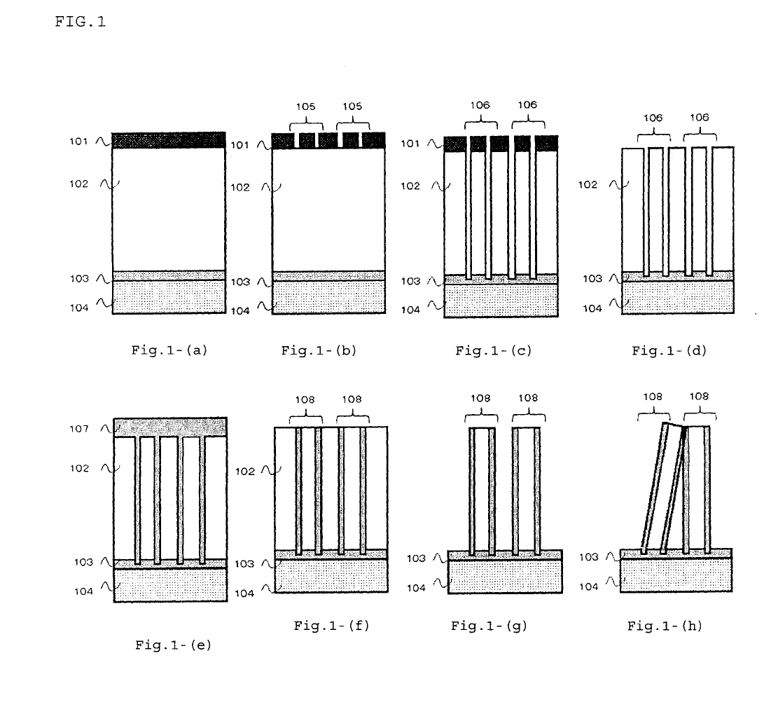

As shown in FIG. 1(a), silicon nitride 103 (thickness: 100 nm) and silicon oxide 102 (thickness: 1,200 nm) were formed as films on a silicon substrate 104, then a photoresist 101 was formed, and the photoresist 101 was exposed and developed, thereby forming a circular and ring-shaped opening 105 (diameter: 125 nm, distance between circles: 70 nm), as shown in FIG. 1(b). The silicon oxide 102 was etched by dry etching with the photoresist 101 as a mask, thereby forming a cylindrical hole 106 reaching the layer of silicon nitride 103, as shown in FIG. 1(c). The photoresist 101 was then removed by ashing, thereby providing a structure having the silicon oxide 102 with the cylindrical hole 106 reaching the layer of silicon nitride 103, as shown in FIG. 1(d). The cylindrical hole 106 of the resulting structure was filled with titanium nitride as a metal 107 (FIG. 1(e)), and an excessive portion of the metal (titanium nitride) 107 on the silicon oxide 102 was removed by chemical mechanical polishing (CMP), thereby providing a structure having the silicon oxide 102 with a cylindrical hollow of the metal (titanium nitride) 108 embedded therein, as shown in FIG. 1(f). The silicon oxide 102 of the resulting structure was removed by dissolving with a 0.5% hydrofluoric acid aqueous solution (by dipping at 25° C. for 1 minute), and then the structure was processed by making into contact with pure water, the processing liquids 1 to 4 (by dipping at 30° C. for 10 minutes), and pure water in this order, followed by drying, thereby providing a structure shown in FIG. 1(g).

The resulting structure had a fine structure with a chimney pattern containing cylindrical hollows of the metal (titanium nitride) (diameter: 125 nm, height: 1,200 nm (aspect ratio: 9.6), distance between the cylindrical hollows: 70 nm), and 70% or more of the pattern was not collapsed.

The pattern collapse was observed with “FE-SEM S-5500 (model number)”, produced by Hitachi High-Technologies Corporation, and the collapse suppression ratio was a value obtained by calculating the ratio of the not collapsed pattern in the total pattern. Cases where the collapse suppression ratio was 50% or more were determined as “passed”. The processing liquids, the processing methods and the results of collapse suppression ratios in the examples are shown in Table 3.

### Comparative Example 1

A structure shown in FIG. 1(g) was obtained in the same manner as in Example 1 except that after removing the silicon oxide 102 of the structure shown in FIG. 1(f) by dissolving with hydrofluoric acid, the structure was processed only with pure water. 50% or more of the pattern of the resulting structure was collapsed as shown in FIG. 1(h) (which indicated a collapse suppression ratio of less than 50%). The processing liquid, the processing method and the result of collapse suppression ratio in Comparative Example 1 are shown in Table 3.

### Comparative Examples 2 to 10

Structures shown in FIG. 1(g) of Comparative Examples 2 to 10 were obtained in the same manner as in Example 1 except that after removing the silicon oxide 102 of the structure shown in FIG. 1(f) by dissolving with hydrofluoric acid and processed with pure water, the structures were processed with the comparative liquids 1 to 9 shown in Table 2 instead of the processing liquid 1.50% or more of the pattern of the resulting structures was collapsed as shown in FIG. 1(h). The processing liquids used in Comparative Examples 2 to 10, the processing methods and the results of collapse suppression ratios in the comparative examples are shown in Table 3.

TABLE 2

| | Name of substance |
|---|---|
| Comparative liquid 1 | isopropyl alcohol |
| Comparative liquid 2 | diethylene glycol monobutyl ether |
| Comparative liquid 3 | N,N-dimethylacetamide |
| Comparative liquid 4 | ammonium polycarboxylate salt *1 |
| Comparative liquid 5 | lauryltrimethylammonium chloride (number of |
| | carbon atoms of alkyl group: 12) *2 |
| Comparative liquid 6 | 2,4,7,9-tetramethyl-5-decine-4,7-diol *3 |
| Comparative liquid 7 | polyoxyethylene polyoxypropylene block |
| | polymer *4 |
| Comparative liquid 8 | ammonium perfluoroalkylsulfonate salt *5 |
| Comparative liquid 9 | perfluoroalkylcarbonate salt *6 |

*1: “DKS Discoat N-14 (product name)”, produced by Dai-ichi Kogyo Seiyaku Co., Ltd., 0.01% aqueous solution
*2: “Catiogen TML (product name)”, produced by Dai-ichi Kogyo Seiyaku Co., Ltd., 0.01% aqueous solution
*3: “Surfynol 104 (product name)”, produced by Nisshin Chemical Industry Co., Ltd., 0.01% aqueous solution
*4: “Epan 420 (product name)”, produced by Dai-ichi Kogyo Seiyaku Co., Ltd., 0.01% aqueous solution
*5: “Fluorad FC-93 (product name)”, produced by 3M Corporation, 0.01% aqueous solution
*6: “Surfron S-111 (product name)”, produced by AGC Seimi Chemical Co., Ltd., 0.01% aqueous solution

TABLE 3

| | | Collapse | |
|---|---|---|---|
| | | suppression | Pass or |
| | Processing method | ratio *1 | fail |
| Example 1 | pure water → processing liquid 1 → pure water → drying | 90% or more | pass |
| Example 2 | pure water → processing liquid 2 → pure water → drying | 80% or more | pass |
| Example 3 | pure water → processing liquid 3 → pure water → drying | 90% or more | pass |
| Example 4 | pure water → processing liquid 4 → pure water → drying | 70% or more | pass |
| Comparative | pure water → drying | less than 50% | fail |
| Example 1 | | | |
| Comparative | pure water → comparative liquid 1 → pure water → drying | less than 50% | fail |
| Example 2 | | | |
| Comparative | pure water → comparative liquid 2 → pure water → drying | less than 50% | fail |
| Example 3 | | | |
| Comparative | pure water → comparative liquid 3 → pure water → drying | less than 50% | fail |
| Example 4 | | | |
| Comparative | pure water → comparative liquid 4 → pure water → drying | less than 50% | fail |
| Example 5 | | | |
| Comparative | pure water → comparative liquid 5 → pure water → drying | less than 50% | fail |
| Example 6 | | | |
| Comparative | pure water → comparative liquid 6 → pure water → drying | less than 50% | fail |
| Example 7 | | | |
| Comparative | pure water → comparative liquid 7 → pure water → drying | less than 50% | fail |
| Example 8 | | | |
| Comparative | pure water → comparative liquid 8 → pure water → drying | less than 50% | fail |
| Example 9 | | | |
| Comparative | pure water → comparative liquid 9 → pure water → drying | less than 50% | fail |
| Example 10 | | | |

*1: collapse suppression ratio = ((number of cylindrical hollows not collapsed)/(total number of cylindrical hollows)) × 100 (%)

### Examples 5 to 8

Structures shown in FIG. 1(g) were obtained in the same manner as in Examples 1 to 4 except that tantalum was used as the metal 107 instead of titanium nitride. The resulting structures had a fine structure with a pattern containing cylindrical hollows 108 of the metal (tantalum) (diameter: 125 nm, height: 1,200 nm (aspect ratio: 9.6), distance between the cylindrical hollows: 70 nm), and 70% or more of the pattern was not collapsed. The processing liquids, the processing methods and the results of collapse suppression ratios in the examples are shown in Table 4.

### Comparative Examples 11 to 20

Structures shown in FIG. 1(g) of Comparative Examples 11 to 20 were obtained in the same manner as in Comparative Examples 1 to 10 except that tantalum was used as the metal 107 instead of titanium nitride. 50% or more of the pattern of the resulting structures was collapsed as shown in FIG. 1(h). The processing liquids, the processing methods and the results of collapse suppression ratios in the examples are shown in Table 4.

TABLE 4

| | | Collapse | |
|---|---|---|---|
| | | suppression | Pass or |
| | Processing method | ratio *1 | fail |
| Example 5 | pure water → processing liquid 1 → pure water → drying | 80% or more | pass |
| Example 6 | pure water → processing liquid 2 → pure water → drying | 80% or more | pass |
| Example 7 | pure water → processing liquid 3 → pure water → drying | 90% or more | pass |
| Example 8 | pure water → processing liquid 4 → pure water → drying | 80% or more | pass |
| Comparative | pure water → drying | less than 50% | fail |
| Example 11 | | | |
| Comparative | pure water → comparative liquid 1 → pure water → drying | less than 50% | fail |
| Example 12 | | | |
| Comparative | pure water → comparative liquid 2 → pure water → drying | less than 50% | fail |
| Example 13 | | | |
| Comparative | pure water → comparative liquid 3 → pure water → drying | less than 50% | fail |
| Example 14 | | | |
| Comparative | pure water → comparative liquid 4 → pure water → drying | less than 50% | fail |
| Example 15 | | | |
| Comparative | pure water → comparative liquid 5 → pure water → drying | less than 50% | fail |
| Example 16 | | | |
| Comparative | pure water → comparative liquid 6 → pure water → drying | less than 50% | fail |
| Example 17 | | | |
| Comparative | pure water → comparative liquid 7 → pure water → drying | less than 50% | fail |
| Example 18 | | | |
| Comparative | pure water → comparative liquid 8 → pure water → drying | less than 50% | fail |
| Example 19 | | | |
| Comparative | pure water → comparative liquid 9 → pure water → drying | less than 50% | fail |
| Example 20 | | | |

*1: collapse suppression ratio = ((number of cylindrical hollows not collapsed)/(total number of cylindrical hollows)) × 100 (%)

### Examples 9 to 12

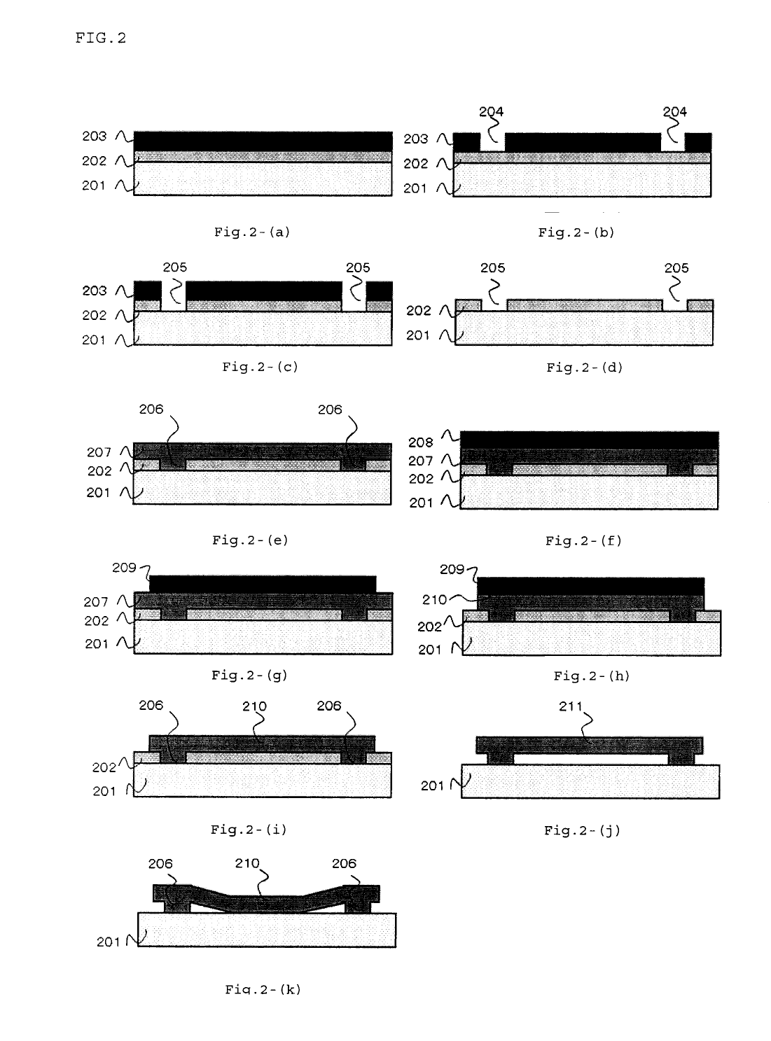

As shown in FIG. 2(a), polysilicon 202 (thickness: 100 nm) was formed on a silicon oxide layer 201 formed on a silicon substrate, and after forming a photoresist 203 thereon, the photoresist 203 was exposed and developed, thereby forming a rectangular columnar opening 204 (1,000 nm×8,000 nm) as shown in FIG. 2(b) was formed. The polysilicon 202 was dry etched with the photoresist 203 as a mask, thereby forming a rectangular columnar hole 205 therein reaching the silicon oxide layer 201 as shown in FIG. 2(c). The photoresist 203 was then removed by ashing, thereby providing a structure having the polysilicon 202 with the rectangular columnar hole 205 therein reaching the silicon oxide layer 201 as shown in FIG. 2(d). The rectangular columnar hole 205 of the resulting structure was filled with titanium, thereby forming a rectangular column of a metal (titanium) 206 and a metal (titanium) layer 207 (FIG. 2(e)), and a photoresist 208 was formed on the metal (titanium) layer 207 (FIG. 2(f)). The photoresist 208 was exposed and developed, thereby forming a photomask 209 having a rectangular shape covering the area including the two rectangular columns of a metal (titanium) 206 as shown in FIG. 2(g), and the metal (titanium) layer 207 was dry etched with the rectangular photomask 209 as a mask, thereby forming a metal (titanium) plate 210 having the rectangular columns of a metal (titanium) 206 at both the ends of the lower part thereof as shown in FIG. 2(h). The rectangular photomask 209 was then removed by ashing, thereby providing a structure having the polysilicon 202 and the metal (titanium) plate 210 having the rectangular columns of a metal (titanium) 206 as shown in FIG. 2(i). The polysilicon 202 of the resulting structure was removed by dissolving with a tetramethylammonium hydroxide aqueous solution, and then the structure was processed by making into contact with pure water, the processing liquids 1 to 5, and pure water in this order, followed by drying, thereby providing a bridge structure 211 shown in FIG. 2(j) of Examples 9 to 12.

The resulting bridge structure 211 had a fine structure with the metal (titanium) plate 210 (length×width: 15,000 nm×10,000 nm, thickness: 300 nm, aspect ratio: 50) and the rectangular columns of a metal (titanium) (length×width: 1,000 nm×8,000 nm, height: 100 nm) at both the ends thereof, and 70% or more of the metal (titanium) plate 210 was not collapsed and was not in contact with the silicon oxide layer 201. The pattern collapse was observed with “FE-SEM S-5500 (model number)”, produced by Hitachi High-Technologies Corporation. The processing liquids, the processing methods and the results of collapse suppression ratios in the examples are shown in Table 5.

### Comparative Examples 21

A bridge structure 211 shown in FIG. 2(j) was obtained in the same manner as in Example 9 except that after removing the polysilicon 202 of the structure shown in FIG. 2(i) by dissolving with a tetramethylammonium hydroxide aqueous solution, the structure was processed only with pure water. 50% or more of the resulting bridge structure 211 was collapsed as shown in FIG. 2(k). The processing liquid, the processing method and the result of collapse suppression ratio in Comparative Example 21 are shown in Table 5.

### Comparative Examples 22 to 30

Bridge structures 211 shown in FIG. 2(j) of Comparative Examples 22 to 30 were obtained in the same manner as in Example 9 except that after removing the polysilicon 202 of the structure shown in FIG. 2(i) by dissolving with a tetramethylammonium hydroxide aqueous solution and processed with pure water, the structure was processed with the comparative liquids 1 to 9 shown in Table 2 instead of the processing liquid 1.50% or more of the resulting bridge structures 211 was collapsed as shown in FIG. 2(k) (which indicated a collapse suppression ratio of less than 50%). The processing liquids, the processing methods and the results of collapse suppression ratios in Comparative Example 22 are shown in Table 5.

TABLE 5

| | | Collapse | |
|---|---|---|---|
| | | suppression | Pass or |
| | Processing method | ratio *1 | fail |
| Example 9 | pure water → processing liquid 1 → pure water → drying | 80% or more | pass |
| Example 10 | pure water → processing liquid 2 → pure water → drying | 80% or more | pass |
| Example 11 | pure water → processing liquid 3 → pure water → drying | 90% or more | pass |
| Example 12 | pure water → processing liquid 4 → pure water → drying | 70% or more | pass |
| Comparative | pure water → drying | less than 50% | fail |
| Example 21 | | | |
| Comparative | pure water → comparative liquid 1 → pure water → drying | less than 50% | fail |
| Example 22 | | | |
| Comparative | pure water → comparative liquid 2 → pure water → drying | less than 50% | fail |
| Example 23 | | | |
| Comparative | pure water → comparative liquid 3 → pure water → drying | less than 50% | fail |
| Example 24 | | | |
| Comparative | pure water → comparative liquid 4 → pure water → drying | less than 50% | fail |
| Example 25 | | | |
| Comparative | pure water → comparative liquid 5 → pure water → drying | less than 50% | fail |
| Example 26 | | | |
| Comparative | pure water → comparative liquid 6 → pure water → drying | less than 50% | fail |
| Example 27 | | | |
| Comparative | pure water → comparative liquid 7 → pure water → drying | less than 50% | fail |
| Example 28 | | | |
| Comparative | pure water → comparative liquid 8 → pure water → drying | less than 50% | fail |
| Example 29 | | | |
| Comparative | pure water → comparative liquid 9 → pure water → drying | less than 50% | fail |
| Example 30 | | | |

*1: collapse suppression ratio = ((number of bridge structures not collapsed)/(total number of bridge structures)) × 100 (%)

### Examples 13 to 16

Bridge structures 211 shown in FIG. 2(j) of Examples 13 to 16 were obtained in the same manner as in Examples 9 to 12 except that aluminum oxide was used as the metal instead of titanium.

The resulting bridge structures 211 had a fine structure with the metal (aluminum oxide) plate 210 (length×width: 15,000 nm×10,000 nm, thickness: 300 nm, aspect ratio: 50) and the rectangular columns of a metal (aluminum oxide) (length×width: 1,000 nm×8,000 nm, height: 100 nm) at both the ends thereof, and 70% or more of the metal (aluminum oxide) plate 210 was not collapsed and was not in contact with the silicon oxide layer 201. The processing liquids, the processing methods and the results of collapse suppression ratios in the examples are shown in Table 6.

### Comparative Examples 31 to 40

Bridge structures 211 shown in FIG. 2(j) of Comparative Examples 31 to 40 were obtained in the same manner as in Comparative Examples 21 to 30 except that aluminum oxide was used as the metal instead of titanium. 50% or more of the resulting bridge structures was collapsed as shown in FIG. 2(k). The processing liquids, the processing methods and the results of collapse suppression ratios in the comparative examples are shown in Table 6.

TABLE 6

| | | Collapse | |
|---|---|---|---|
| | | suppression | Pass or |
| | Processing method | ratio *1 | fail |
| Example 13 | pure water → processing liquid 1 → pure water → drying | 90% or more | pass |
| Example 14 | pure water → processing liquid 2 → pure water → drying | 90% or more | pass |
| Example 15 | pure water → processing liquid 3 → pure water → drying | 70% or more | pass |
| Example 16 | pure water → processing liquid 4 → pure water → drying | 80% or more | pass |
| Comparative | pure water → drying | less than 50% | fail |
| Example 31 | | | |
| Comparative | pure water → comparative liquid 1 → pure water → drying | less than 50% | fail |
| Example 32 | | | |
| Comparative | pure water → comparative liquid 2 → pure water → drying | less than 50% | fail |
| Example 33 | | | |
| Comparative | pure water → comparative liquid 3 → pure water → drying | less than 50% | fail |
| Example 34 | | | |
| Comparative | pure water → comparative liquid 4 → pure water → drying | less than 50% | fail |
| Example 35 | | | |
| Comparative | pure water → comparative liquid 5 → pure water → drying | less than 50% | fail |
| Example 36 | | | |
| Comparative | pure water → comparative liquid 6 → pure water → drying | less than 50% | fail |
| Example 37 | | | |
| Comparative | pure water → comparative liquid 7 → pure water → drying | less than 50% | fail |
| Example 38 | | | |
| Comparative | pure water → comparative liquid 8 → pure water → drying | less than 50% | fail |
| Example 39 | | | |
| Comparative | pure water → comparative liquid 9 → pure water → drying | less than 50% | fail |
| Example 40 | | | |

*1: collapse suppression ratio = ((number of bridge structures not collapsed)/(total number of bridge structures)) × 100 (%)

### Examples 17 to 20

Bridge structures 211 shown in FIG. 2(j) of Examples 17 to 20 were obtained in the same manner as in Examples 9 to 12 except that hafnium oxide was used as the metal instead of titanium.

The resulting bridge structures 211 had a fine structure with the metal (hafnium oxide) plate 210 (length×width: 15,000 nm×10,000 nm, thickness: 300 nm, aspect ratio: 50) and the rectangular columns of a metal (hafnium oxide) (length×width: 1,000 nm×8,000 nm, height: 100 nm) at both the ends thereof, and 70% or more of the metal (hafnium oxide) plate 210 was not collapsed and was not in contact with the silicon oxide layer 201. The processing liquids, the processing methods and the results of collapse suppression ratios in the examples are shown in Table 7.

### Comparative Examples 41 to 50

Bridge structures 211 shown in FIG. 2(j) of Comparative Examples 41 to 50 were obtained in the same manner as in Comparative Examples 21 to 30 except that hafnium oxide was used as the metal instead of titanium. 50% or more of the resulting bridge structures was collapsed as shown in FIG. 2(k). The processing liquids, the processing methods and the results of collapse suppression ratios in the comparative examples are shown in Table 7.

TABLE 7

| | | Collapse | |
|---|---|---|---|
| | | suppression | Pass or |
| | Processing method | ratio *1 | fail |
| Example 17 | pure water → processing liquid 1 → pure water → drying | 90% or more | pass |
| Example 18 | pure water → processing liquid 2 → pure water → drying | 90% or more | pass |
| Example 19 | pure water → processing liquid 3 → pure water → drying | 80% or more | pass |
| Example 20 | pure water → processing liquid 4 → pure water → drying | 80% or more | pass |
| Comparative | pure water → drying | less than 50% | fail |
| Example 41 | | | |
| Comparative | pure water → comparative liquid 1 → pure water → drying | less than 50% | fail |
| Example 42 | | | |
| Comparative | pure water → comparative liquid 2 → pure water → drying | less than 50% | fail |
| Example 43 | | | |
| Comparative | pure water → comparative liquid 3 → pure water → drying | less than 50% | fail |
| Example 44 | | | |
| Comparative | pure water → comparative liquid 4 → pure water → drying | less than 50% | fail |
| Example 45 | | | |
| Comparative | pure water → comparative liquid 5 → pure water → drying | less than 50% | fail |
| Example 46 | | | |
| Comparative | pure water → comparative liquid 6 → pure water → drying | less than 50% | fail |
| Example 47 | | | |
| Comparative | pure water → comparative liquid 7 → pure water → drying | less than 50% | fail |
| Example 48 | | | |
| Comparative | pure water → comparative liquid 8 → pure water → drying | less than 50% | fail |
| Example 49 | | | |
| Comparative | pure water → comparative liquid 9 → pure water → drying | less than 50% | fail |
| Example 50 | | | |

*1: collapse suppression ratio = ((number of bridge structures not collapsed)/(total number of bridge structures)) × 100 (%)

### Examples 21 to 24

Bridge structures 211 shown in FIG. 2(j) of Examples 21 to 24 were obtained in the same manner as in Examples 9 to 12 except that ruthenium was used as the metal instead of titanium.

The resulting bridge structures 211 had a fine structure with the metal (ruthenium) plate 210 (length×width: 15,000 nm×10,000 nm, thickness: 300 nm, aspect ratio: 50) and the rectangular columns of a metal (ruthenium) (length×width: 1,000 nm×8,000 nm, height: 100 nm) at both the ends thereof, and 70% or more of the metal (ruthenium) plate 210 was not collapsed and was not in contact with the silicon oxide layer 201. The pattern collapse was observed with “FE-SEM S-5500 (model number)”, produced by Hitachi High-Technologies Corporation. The processing liquids, the processing methods and the results of collapse suppression ratios in the examples are shown in Table 8.

### Comparative Examples 51 to 60

Bridge structures 211 shown in FIG. 2(j) of Comparative Examples 51 to 60 were obtained in the same manner as in Comparative Examples 21 to 30 except that ruthenium was used as the metal instead of titanium. 50% or more of the resulting bridge structures was collapsed as shown in FIG. 2(k). The processing liquids, the processing methods and the results of collapse suppression ratios in the comparative examples are shown in Table 8.

TABLE 8

| | | Collapse | |
|---|---|---|---|
| | | suppression | Pass or |
| | Processing method | ratio *1 | fail |
| Example 21 | pure water → processing liquid 1 → pure water → drying | 80% or more | pass |
| Example 22 | pure water → processing liquid 2 → pure water → drying | 70% or more | pass |
| Example 23 | pure water → processing liquid 3 → pure water → drying | 80% or more | pass |
| Example 24 | pure water → processing liquid 4 → pure water → drying | 80% or more | pass |
| Comparative | pure water → drying | less than 50% | fail |
| Example 51 | | | |
| Comparative | pure water → comparative liquid 1 → pure water → drying | less than 50% | fail |
| Example 52 | | | |
| Comparative | pure water → comparative liquid 2 → pure water → drying | less than 50% | fail |
| Example 53 | | | |
| Comparative | pure water → comparative liquid 3 → pure water → drying | less than 50% | fail |
| Example 54 | | | |
| Comparative | pure water → comparative liquid 4 → pure water → drying | less than 50% | fail |
| Example 55 | | | |
| Comparative | pure water → comparative liquid 5 → pure water → drying | less than 50% | fail |
| Example 56 | | | |
| Comparative | pure water → comparative liquid 6 → pure water → drying | less than 50% | fail |
| Example 57 | | | |
| Comparative | pure water → comparative liquid 7 → pure water → drying | less than 50% | fail |
| Example 58 | | | |
| Comparative | pure water → comparative liquid 8 → pure water → drying | less than 50% | fail |
| Example 59 | | | |
| Comparative | pure water → comparative liquid 9 → pure water → drying | less than 50% | fail |
| Example 60 | | | |

*1: collapse suppression ratio = ((number of bridge structures not collapsed)/(total number of bridge structures)) × 100 (%)

### INDUSTRIAL APPLICABILITY

The processing liquid of the present invention may be used favorably for suppressing pattern collapse of a fine metal structure, such as a semiconductor device and a micromachine (MEMS).

### DESCRIPTION OF THE SYMBOLS

101 photoresist
102 silicon oxide
103 silicon nitride
104 silicon substrate
105 circular opening
106 cylindrical hole
107 metal (titanium nitride or tantalum)
108 cylindrical hollow of metal (titanium nitride or tantalum)
201 silicon oxide layer
202 polysilicon
203 photoresist
204 rectangular columnar opening
205 rectangular columnar hole
206 rectangular column of metal (titanium, aluminum oxide, hafnium oxide or ruthenium)
207 metal (titanium, aluminum oxide, hafnium oxide or ruthenium) layer
208 photoresist
209 rectangular photomask
210 metal (titanium, aluminum oxide, hafnium oxide or ruthenium) plate
211 bridge structure

1. A processing liquid, comprising:
a pattern collapse suppressing agent comprising a hydrocarbyl group comprising any one of an alkyl group and an alkenyl group and an oxyethylene structure,
wherein the alkyl group and the alkenyl group are optionally substituted with one or more a fluorine atoms.

2. The processing liquid of claim 1, wherein the pattern collapse suppressing agent comprises at least one selected from the group consisting of a hydrocarbyl alkanolamide, a polyoxyethylene hydrocarbylamine, and a perfluoroalkyl polyoxyethylene ethanol.

3. The processing liquid of claim 2, wherein the suppressing agent comprises a hydrocarbyl alkanolamide of formula (1): 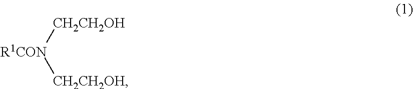
wherein R¹ is an alkyl group comprising from 2 to 24 carbon atoms or an alkenyl group.

4. The processing liquid of claim 2, wherein the suppressing agent comprises a polyoxyethylene hydrocarbylamine of formula (2): 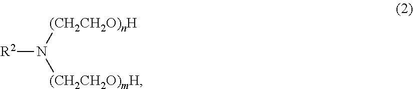
wherein:
R² is an alkyl group comprising from 2 to 24 carbon atoms or an alkenyl group; and
n and m are each independently an integer of from 0 to 20, provided that m+n is 1 or more.

5. The processing liquid of claim 2, wherein the suppressing agent comprises a perfluoroalkyl polyoxyethylene ethanol of formula (3):
CF₃(CF₂)ₙ(CH₂CH₂O)ₘCH₂CH₂OH (3)
wherein n and m are each independently an integer of from 1 to 20.

6. The processing liquid of claim 1, further comprising water.

7. The processing liquid of claim 2, wherein a content of the pattern collapse suppressing agent in the processing liquid is from 10 ppm to 10 mass %, based on a total mass of the processing liquid.

8. The processing liquid of claim 1, being suitable for suppressing pattern collapse of a fine metal structure, wherein the fine metal structure comprises at least one material selected from titanium nitride, titanium, ruthenium, ruthenium oxide, aluminum oxide, hafnium oxide, hafnium silicate, hafnium nitride silicate, platinum, tantalum, tantalum oxide, tantalum nitride, nickel silicide, nickel silicon germanium and nickel germanium.

9. A method for producing a fine metal structure, the process comprising:
wet etching or dry etching a structure, to obtain a fine metal structure; and then
rinsing the fine metal structure with the processing liquid of claim 1.

10. The method of claim 9, wherein the fine metal structure comprises at least one material selected from titanium nitride, titanium, ruthenium, ruthenium oxide, aluminum oxide, hafnium oxide, hafnium silicate, hafnium nitride silicate, platinum, tantalum, tantalum oxide, tantalum nitride, nickel silicide, nickel silicon germanium, and nickel germanium.

11. The method of claim 9, wherein the fine metal structure is a semiconductor device or a micromachine.

12. The processing liquid of claim 2, wherein a content of the pattern collapse suppressing agent in the processing liquid is from 10 to 2,000 ppm, based on a total mass of the processing liquid.

13. The processing liquid of claim 2, wherein a content of the pattern collapse suppressing agent in the processing liquid is from 10 to 1,000 ppm, based on a total mass of the processing liquid.

14. The processing liquid of claim 3, wherein, in formula (1), R¹ is an alkyl group comprising from 8 to 18 carbon atoms.

15. The processing liquid of claim 3, wherein, in formula (1), R¹ is an alkenyl group comprising from 6 to 18 carbon atoms.

16. The processing liquid of claim 4, wherein, in formula (2), R² is an alkyl group comprising from 8 to 18 carbon atoms.

17. The processing liquid of claim 4, wherein, in formula (1), R² is an alkenyl group comprising from 6 to 18 carbon atoms.
